(19) United States
(12) Patent Application Publication
(10) Pub. No.: US 2006/0285573 A1
(43) Pub. Date: Dec. 21, 2006

(54) PORTABLE INCLINOMETER

(75) Inventor: Dezhong Yang, Nanjing (CN)

Correspondence Address: WALLENSTEIN & WAGNER, LTD., 311 SOUTH WACKER DRIVE, 53RD FLOOR, CHICAGO, IL, 60606, US

(73) Assignee: Nanjing Chervon Industry Co., Ltd., Nanjing (CN)

(21) Appl. No.: 11/423,876

(22) Filed: Jun. 13, 2006

(30) Foreign Application Priority Data
Jun. 17, 2005 (CN) 200520072771.8

(51) Int. Cl. G01N 25/00

(52) U.S. Cl. 374/6

(57) ABSTRACT

The present invention is to provide a portable electronic inclinometer with simplified structure, improved anti-impact and anti-vibration properties, and high precision. The inclinometer comprises a casing, a display unit and a set of operational buttons provided on the casing, a measuring circuit installed inside the casing and a power supply supplying power to the display unit and the measuring circuit. The casing includes a reference measuring surface. The measuring circuit includes a tilting angle sensing unit. The tilting angle sensing unit comprises a gas-filled sealed chamber, a heating element and a set of temperature sensing elements arranged inside the chamber. The set of temperature sensing elements comprises at least one pair of temperature sensing elements symmetrically arranged about the heating element. The tilting angle sensing unit has a first axis extending across the heating element. A first pair of temperature sensing elements symmetrically arranged about the heating element is disposed along the first axis. The first axis is parallel to the reference measuring surface of the casing.

### CROSS-REFERENCE TO RELATED APPLICATIONS

This application claims priority to Chinese Application No. 200520072771.8, filed on Jun. 17, 2005, the entire disclosure of which is incorporated herein by reference. Priority to this application is claimed under 35 U.S.C. 119, 120 and/or 365.

### TECHNICAL FIELD

The present invention relates to an inclinometer, and particularly to a portable electronic inclinometer by utilizing the measurement principle of hot air mass convection.

### BACKGROUND OF THE INVENTION

It is a common practice to measure the tilting angle of a plane surface in building engineering, house decoration and other constructional engineering. A simple inclinometer could be a calibrated bubble or a solid-pendulum with a pointer and a dial. However, the measure precision with them is not sufficient and the measurement error is rather high resulting from reading by an operator himself according to the indicating of the above-mentioned devices.

More precise electronic inclinometers in the art normally are electrolytic type inclinometer and solid-pendulum type inclinometer. Based on the principle that the surface of electrolyte always keeps level, an electrolytic type inclinometer measures the depth variations of its electrodes immerged in the electrolyte to obtain the tilting angle. A solid-pendulum type inclinometer, based on the principle that the pendulum will always keep plumb under gravitation, converts the offset of the pendulum from a reference position into an electrical signal to calculate the tilting angle. However, these electronic inclinometers have rather complicated structures, and poor anti-impact and anti-vibration performance, and they are easily damaged.

The present invention is provided to solve the problems discussed above and other problems, and to provide advantages and aspects not provided by prior inclinometers of this type. A full discussion of the features and advantages of the present invention is deferred to the following detailed description, which proceeds with reference to the accompanying drawings.

### SUMMARY OF THE INVENTION

An object of the invention is to provide a portable electronic inclinometer with simplified structure, improved anti-impact and anti-vibration properties, and with high precision.

In order to fulfill the above object, an inclinometer provided by this invention comprises a casing, a measurement display unit and a set of operational buttons provided on the casing, a measuring circuit installed inside the casing and a power supply supplying power to the display unit and the measuring circuit. The casing comprises a reference measuring surface. The measuring circuit comprises a tilting angle sensing unit which includes a gas-filled sealed chamber. Inside the chamber, there is a heating element and a set of temperature sensing elements which comprises at least one pair of temperature sensing elements symmetrically arranged about the heating element.

During measuring, the gas inside the sealed chamber is heated by the heating element with a result that a hot gas mass which can be moved freely in the chamber is created. While the tilting angle sensing unit is placed horizontally, the temperature distribution of the hot gas mass is centrally symmetric about the heating element. In this case, the temperatures detected by all the temperature sensing elements are identical and therefore their output electronic signals are on a same level. On the other hand, when the tilting angle sensing unit is tilted, owing to the gravitation, free convection will occur with the hot gas mass, which will result in a variation of the temperature distribution of the hot gas mass, so that there will be a difference between the output electronic signals from each pair of temperature sensing elements. The difference is proportional to the tilting degree of the tilting angle sensing unit and therefore, based on the difference, the tilting angle can be calculated. By utilizing the freely convectable hot gas mass as a gravity block, the structure of the inclinometer can be simplified with greatly improved anti-impact and anti-vibration properties.

According to the present invention, the tilting angle sensing unit of the measuring circuit of the inclinometer has a first axis extending across the heating element. A first pair of temperature sensing elements located symmetric about the heating element is disposed along the first axis. The first axis is parallel to the reference measuring surface of the casing, so that the tiling angle of the first axis will be the tilting angle of the reference measuring surface.

The tilting angle sensing unit of the measuring circuit of the inclinometer according to the present invention may further have a second axis extending across the heating element and perpendicular to the first axis. A second pair of temperature sensing elements which are located symmetric about the heating element is disposed along the second axis. The second axis is perpendicular to the reference measuring surface of the casing. Combining the measurements based on both the first axis and the second axis, the error in the temperature sensing part resulting from temperature variation can be partially decreased and the precision of measurement can be further improved.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of an inclinometer according to a preferred embodiment of the present invention;

FIG. 2a is a schematic diagram of a tilting angle sensing unit in a measuring circuit of the inclinometer according to the preferred embodiment of the present invention;

FIG. 2b is a schematic diagram of the tilting angle sensing unit in FIG. 2a during a measuring process;

FIG. 3a is a schematic diagram of a tilting angle sensing unit in a measuring circuit of an inclinometer according to another preferred embodiment of the present invention; and,

FIG. 3b is a schematic diagram of the tilting angle sensing unit in FIG. 3a during a measuring process.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

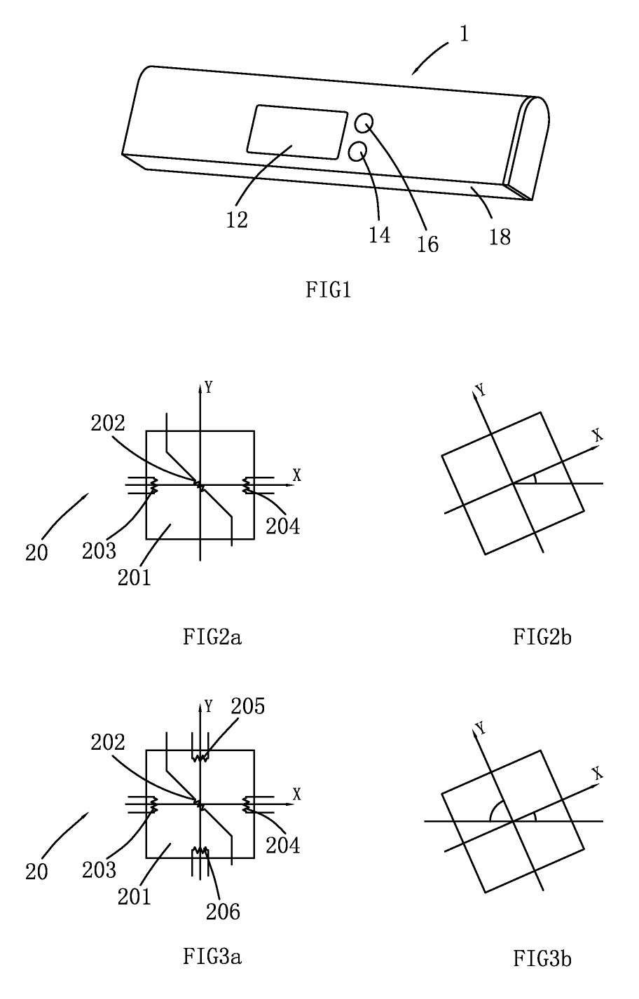

FIG. 1 illuminates an inclinometer 1 according to a preferred embodiment of the present invention. The inclinometer 1 comprises a casing 11, a display unit 12 and a set of buttons on the casing 11, and a power supply (not shown in FIG. 1) and a measuring circuit (not shown in FIG. 1) both of which are installed inside the casing 11. The set of buttons comprises a power button 14. Obviously, other buttons can be provided according to requirements of the functions. For example, a storing button 16 can be added to store the last measurement data. The inclinometer 1 has a reference measuring surface. It is preferred to predetermine a bottom surface 18 of the casing 11 as the reference measuring surface. The displayed measurement data on the display unit 12 is the tilting angle of the reference measuring surface 18. During measuring, it is necessary to abut the reference measuring surface 18 against a surface to be measured. Those skilled in the art will understand that other appropriate portions of the casing can also be used as the reference measuring surface.

FIG. 2a is a principle schematic diagram of a measuring circuit of the inclinometer 1 according to the preferred embodiment of the present invention. The measuring circuit comprises a tilting angle sensing unit 20 and a signal processing unit (not shown). The tilting angle sensing unit 20 comprises a gas-filled sealed chamber 201. Inside the sealed chamber 201, a heating element 202 and a pair of temperature sensing elements 203 and 204 are contained. The gas filled in the sealed chamber 201 may be air or other type of appropriate gases. The heating element 202 is located in the central part of the sealed chamber 201. The temperature sensing elements 203 and 204 are located symmetrically about the heating element 202. The tilting angle sensing unit 20 has an axis X extending across the heating element 202 and another axis Y which is also extending across the heating element 202 and orthogonal to the axis X. The temperature sensing elements 203 and 204 are both disposed along the axis X, and their output terminals are separately connected to the signal processing unit, which, in turn, will process the output signals from the temperature sensing elements 203 and 204 and calculate the tilting angle of the axis X.

While the inclinometer 1 is in operation, the heating element 202 will be used to heat the gas in the sealed chamber 201 to create a hot gas mass. If the axis X is in horizontal direction, the temperature distribution of the hot gas mass is symmetric about the axis Y, the temperature values detected by the temperature sensing elements 203 and 204 are thus identical. And therefore their output electronic signals is identical too. Once the axis X is tilted, due to the gravitation, free convection will occur with the hot gas mass, which will result in an asymmetric temperature distribution about the axis Y, the temperature values detected by the temperature sensing elements 203 and 204 is thus different from each other, and therefore, there is a difference between the two output electronic signals. The difference is a function of the tilting angle of the axis X, which can be expressed as: x=g sin α, wherein x is the difference between the output electronic signal from the temperature sensing elements 203 and 204 respectively, g is the acceleration of gravity and α is the angle between axis X and horizontal plane, as shown in FIG. 2b. Then, a formula calculating the angle α between the axis X and the horizontal plane can be obtained: α=sin⁻¹(x/g). Preferably, the axis X of the tilting angle sensing unit 20 is parallel to the reference surface 18 on the casing 1. In this case, the tilting angle of the axis X is the tilting angle of the reference surface and no additional calculation is needed.

By means of the above mentioned method, a precise measurement of a tilting angle relative to the horizontal plane can be achieved in the range of 0-90 degrees. It should be noted that while a tilting angle is close to 90°, the variation of the difference between the output electronic signals from the two temperature sensing elements will not be big enough, and as a result, it is difficult for the signal processing circuit to precisely distinguish these angles. However, in most cases, the above mentioned method can satisfy the requirement for tilting angle measurement.

According to another preferred embodiment of the present invention, the tilting angle sensing unit 20 may further include another pair of temperature sensing elements 205 and 206 which are located along the axis Y and symmetric about the heating element, as shown in FIG. 3a. The output terminals of the temperature sensing elements 205, 206 are also connected to the signal processing unit of the measuring circuit. In this embodiment, the tilting angle sensing unit 20 is arranged vertically with its axis X parallel to the reference measuring surface and axis Y perpendicular to the reference measuring surface. In this case, the angle between the axis Y and a horizontal plane is 90°−α. Since x=g sin α, then y=g cos α, where y is the difference between the output signals from temperature sensing elements 205 and 206 which are located along the axis Y respectively. From the above formulae, α=tan⁻¹(x/y) can be derived. In this case, based on the arctangent function, angles close to 90° can be precisely distinguished by the tilting angle sensing unit. Moreover, the measurement errors of the tilting angle sensing unit 20 at the axis X and the axis Y, which result from the influence of the ambient temperature and the elevated temperature of the measuring circuit itself, can thus be offset against each other. Therefore the measurement precision can be further improved.

The above description and drawings of the preferred embodiments are only used to describe and illustrate the principle and content of the present invention, but not to limit the claimed scope of the present invention. It will be understand by those ordinary skilled in the art that there will be other alternatives, modifications and equivalents within the spirit and scope of the present invention. The spirit and scope of the invention are defined by the appended claims.

What is claimed is:

1. An apparatus for measuring an inclination of a substrate, comprising:
a casing having a measuring surface;
a chamber disposed within the casing;
a heating element for heating a gas within the chamber; and,
a temperature sensor for sensing the temperature of the gas.

2. The apparatus of claim 1, further comprising:
a processing unit for receiving a signal representative of the temperature of the gas.

3. The apparatus of claim 2, wherein the processing unit comprises logic for determining a temperature differential based on data read from the signal.

4. The apparatus of claim 2, wherein the processing unit comprises logic for executing a trigonometric function involving data read from the signal.

5. The apparatus of claim 1, further comprising:
a second temperature sensor for sensing the temperature of the gas, wherein the temperature sensor and the second temperature sensor are positioned within the chamber symmetrically around the heating element.

6. The apparatus of claim 5, wherein a difference between a first temperature sensed by the temperature sensor and a second temperature sensed by the second temperature sensor represents a temperature differential.

7. The apparatus of claim 5, wherein the temperature sensor and the second temperature sensor form a first axis parallel to the measuring surface.

8. The apparatus of claim 7, further comprising:
a third temperature sensor; and, a fourth temperature sensor, wherein the third and fourth temperature sensors are positioned within the chamber symmetrically around the heating element, forming a second axis orthogonal to the first axis and perpendicular to the measuring surface.

9. The apparatus of claim 8, wherein a difference between a first temperature sensed by the third temperature sensor and a second temperature sensed by the fourth temperature sensor represents a temperature differential.

10. An apparatus for measuring an inclination of a substrate, comprising:
a sealed chamber disposed within a casing and containing a gas;
a heating element disposed in the middle of the sealed chamber, wherein the heating element heats the gas;
a first temperature sensor for measuring a first temperature of the gas at a first location within the sealed chamber;
a second temperature sensor for measuring a second temperature of the gas at a second location within the sealed chamber; and,
a processing unit for determining the inclination of the substrate by executing a function on a temperature differential represented by a difference between the first and second temperatures.

11. The apparatus of claim 10, wherein the first and second locations are positioned symmetrically around the heating element and form an axis parallel to the substrate.

12. The apparatus of claim 10, further comprising:
a third temperature sensor for measuring a third temperature of the gas at a third position within the sealed chamber; and,
a fourth temperature sensor for measuring a fourth temperature of the gas at a fourth position within the sealed chamber.

13. The apparatus of claim 12, wherein the third and fourth locations are positioned symmetrically around the heating element and form an axis perpendicular to the substrate.

14. The apparatus of claim 12, wherein the function is executed on the temperature differential and a second temperature differential represented by a difference between the third and fourth temperatures.

15. The apparatus of claim 10, further comprising:
a display disposed on an exterior of the casing, for displaying the inclination of the substrate.

16. The apparatus of claim 10, wherein the function is an inverse trigonometric function.

17. The apparatus of claim 10, further comprising:
a power supply for supplying electrical power to the temperature sensors, the heating element and the processing unit.

18. The apparatus of claim 10, further comprising:
an operational button disposed on an exterior of the casing, for transmitting a signal to the heating element to heat the gas.

19. The apparatus of claim 10, wherein the processing unit comprises logic for offsetting the first and second temperatures against a base reference temperature representing an ambient temperature of the casing.

20. An apparatus for measuring an angular inclination of a substrate, comprising:
a casing having a measuring surface to be positioned parallel to the substrate;
a sealed chamber disposed within the casing, wherein the sealed chamber contains a gas;
a heating element disposed at a central point within the sealed chamber for heating the gas;
a first temperature sensor disposed at a first position within the sealed chamber for sensing a first temperature of the gas;
a second temperature sensor disposed at a second position within the sealed chamber for sensing a second temperature of the gas, wherein the first second positions are disposed symmetrically around the heating element and form a first axis parallel to the measuring surface;
a third temperature sensor disposed at a third position within the sealed chamber for sensing a third temperature of the gas;
a fourth temperature sensor disposed at a fourth position within the sealed chamber for sensing a fourth temperature of the gas, wherein the third and fourth positions are disposed symmetrically around the heating element and form a second axis orthogonal to the first axis and perpendicular to the measuring surface; and,
a processing unit for receiving electrical signals representative of the first, second, third and fourth temperatures, wherein the processing unit comprises:
first logic for determining a first temperature differential between the first and second temperatures;
second logic for determining a second temperature differential between the third and fourth temperatures; and,
third logic for executing an arctangent function on the first and second temperature differentials, wherein the arctangent function is the angular inclination of the substrate.
